(19) United States
(12) Patent Application Publication
(10) Pub. No.: US 2017/0005393 A1
(43) Pub. Date: Jan. 5, 2017

(54) ANTENNA MODULE AND MOBILE DEVICE USING SAME

(71) Applicant: Jing Wu, Shenzhen (CN)

(72) Inventor: Jing Wu, Shenzhen (CN)

(73) Assignee: AAC Technologies Pte. Ltd., Singapore city (SG)

(21) Appl. No.: 15/008,583

(22) Filed: Jan. 28, 2016

(30) Foreign Application Priority Data
Jul. 2, 2015 (CN) 201520469050.4

(51) Int. Cl. H01Q 1/24; H01Q 23/00; H01Q 9/04

(52) U.S. Cl. CPC H01Q 1/243; H01Q 9/04; H01Q 23/00

(57) ABSTRACT

An antenna module is provided in the present disclosure. The antenna module includes a printed circuit board and a metal frame surrounding the printed circuit board. The metal frame includes a metal radiating portion, and a first feed point, a second feed point, a first ground point and a second ground point are disposed on the printed circuit board and electrically connected to the metal radiating portion. The first feed point and the second feed point are symmetrically disposed at two opposite sides of a central axis of the printed circuit board; the first ground point and the second ground point are respectively disposed corresponding to the first feed point and the second feed point. The present disclosure also provides a mobile device using the antenna module.

### FIELD OF THE DISCLOSURE

The present disclosure generally relates to mobile communication technologies, and more particularly, to an antenna module and a mobile device using the antenna module.

### BACKGROUND

With development of mobile communication technologies, mobile devices such as mobile phones, tablet computers, or the like, are used more and more widely. Mobile devices normally use antenna modules to convert electric power into radio waves, and vice versa, so as to enable the mobile devices to perform wireless transmission and reception.

Mobile devices with metal shells are preferred by people because of their fashion appearance as well as good durability. However, a metal shell may bring an electromagnetic shielding effect against the antenna module of the mobile communication device, and decrease a radiation performance of the antenna module. In order to improve a radiation space of the antenna module, in a related mobile device, an antenna module is designed to feed to a metal frame or a metal back cover of the mobile device directly. Nevertheless, when the mobile device is held by a user's hand, the user's hand directly contacts the metal frame or the metal back cover, which may deteriorate a radio frequency (RF) performance of the antenna module.

Therefore, it is desired to provide a new antenna module which can overcome the aforesaid problems.

### BRIEF DESCRIPTION OF THE DRAWINGS

Many aspects of the embodiment can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 is a schematic planar view of an antenna module according to an embodiment of the present disclosure.

FIG. 2 is a partial view of the antenna module of FIG. 1.

### DETAILED DESCRIPTION

The present disclosure will be described in detail below with reference to the attached drawings and the embodiment thereof.

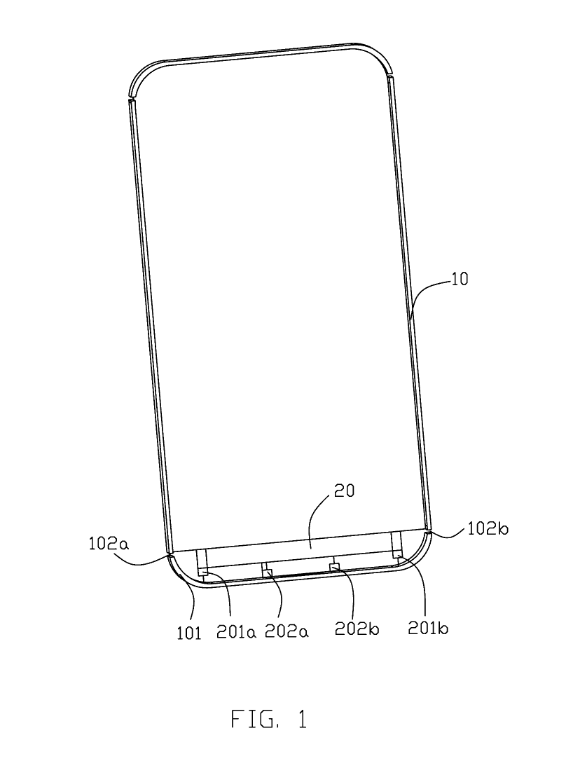

Referring to FIG. 1, an antenna module 100 according to an embodiment of the present disclosure is shown. The antenna module 100 is applicable to a mobile device such as a mobile phone, a tablet computer, or the like. As illustrated in FIG. 1, the antenna module 100 includes a printed circuit board (PCB) 20 and a metal frame 10 surrounding the printed circuit board 20. A pair of feed points 202a, 202b and a pair of ground points 201a, 201b are formed on the printed circuit board 20; in the following description, the pair of feed points 202a and 202b are respectively defined as a first feed point 202a and a second feed point 202b; similarly, the pair of ground points 201a and 201b are respectively defined as a first ground point 201a and a second ground point 201b.

The metal frame 10 includes a metal radiating portion 101, the metal radiating portion 101 faces the printed circuit board 20 and is apart from the printed circuit board 20 at a certain distance. For example, the mobile device in which the antenna module 100 is applied may include a receiver adjacent to an upper end of the mobile device, and a microphone adjacent to a lower end thereof; the antenna module 100 may be disposed at the lower end of the mobile device, and in this circumstance, a portion of the metal frame 10 corresponding to the lower end of the mobile device serves as the metal radiating portion 101.

An area surrounded by the metal radiating portion 101 and the printed circuit board 20 is defined as a clearance area of the antenna module 100. In the clearance area, the first feed point 202a and the second feed point 202b are symmetrically disposed at two opposite sides of a central axis of the printed circuit board 20, and are electrically connected to the metal radiating portion 101; the first ground point 201a and the second ground point 201b are also symmetrically disposed at two opposite sides of the central axis of the printed circuit board 20, and are electrically connected to the metal radiating portion 101. The first ground point 201a and the second ground point 201b correspond to the first feed point 202a and the second ground point 202b respectively. In the present embodiment, the first feed point 202a is located between the first ground point 201a and the central axis of the printed circuit board 20; the second feed point 202b is located between the second ground point 201b and the central axis of the printed circuit board 20.

It should be noted that in practice a distance between the first ground point 201a and the first feed point 202a, as well as a distance between the second ground point 201b and the second feed point 202b, can be adjusted according to an actual frequency range of the antenna module 100; in other words, the first ground point 201a and the second ground point 201b may alternatively be asymmetrical in other embodiments.

The metal radiating portion 101 includes a bottom plate and two arc-shaped plates, the two arc-shaped plates respectively extend from two opposite ends of the bottom plate. A pair of break points 102a and 102b (namely, a first break point 102a and a second break point 102b) are formed at the metal radiating portion 101, which can typically be formed as two openings or recesses. The first break point 102a and the second break point 102b may be symmetrically disposed at two opposite sides of the central axis of the printed circuit board 20.

For example, the first break point 102a and the second break point 102b are respectively formed at ends of the two arc-shaped plates, as illustrated in FIG. 1; alternatively, in other embodiments, the first break point 102a and the second break point 102b may be formed at the bottom plate of the metal radiating portion 101.

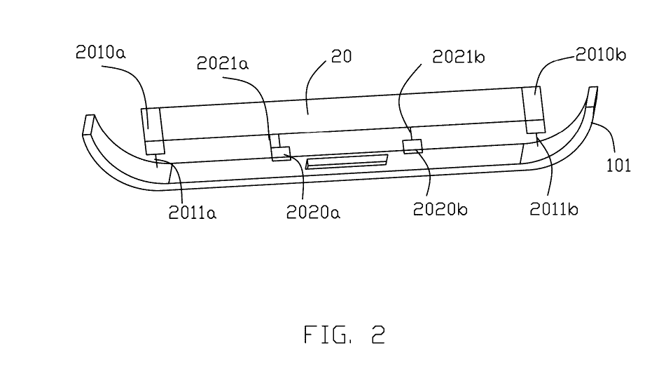

Referring also to FIG. 2, in the present embodiment, the first feed point 202a and the first ground point 201a are both disposed at a left side of the antenna module 100. The first feed point 202a includes a first feed piece 2020a electrically connected to the metal radiating portion 101, and a first connecting piece 2021a electrically connected between the first feed piece 2020a and the printed circuit board 20; the first ground point 201a includes a first ground piece 2010a attached on and electrically connected to the printed circuit board 20, and a second connecting piece 2011a electrically connected between the first ground piece 2010a and the metal radiating portion 101.

Similarly, the second feed point 202b and the second ground point 201b are both disposed at a right side of the antenna module 100. The second feed point 202b includes a second feed piece 2020b electrically connected to the metal radiating portion 101, and a third connecting piece 2021b electrically connected between the second feed piece 2020b and the printed circuit board 20; the second ground point 201b includes a second ground piece 2010b attached on and electrically connected to the printed circuit board 20, and a fourth connecting piece 2011b electrically connected between the second ground piece 2010b and the metal radiating portion 101.

Furthermore, the antenna module 100 according to the present disclosure may also include a feed control switch electrically connected to the printed circuit board 20. The feed control switch is configured for controlling operation states of the first feed point 202a and the second feed point 202b. In the present embodiment, the feed control switch may control the operation states of the first feed point 202a and the second feed point 202b by switching on or switching off the first connecting piece 2021a and the third connecting piece 2021b.

In particular, the feed control switch may selectively control one of the first feed point 202a and the second feed point 202b to enter an short circuit state (ON state) and perform feeding operation, and control the other one to enter an open circuit state (OFF state) and stop functioning. Moreover, the ON/OFF states of the first feed point 202a and the second feed point 202b may also be switched by the feed control switch. As such, the antenna module 100 is enabled to realize substantially full frequency coverage.

When the mobile device using the antenna module 100 is held by a user's right hand, the second feed point 202b at the right side may impact radio frequency (RF) performance of the antenna module 100. In this situation, the feed control switch can control the first feed point 202a at the left side to perform feeding operation and control the second feed point 202b at the right side to stop functioning. Since the first feed point 202a at the left side is barely impacted by the user's right hand, the antenna module 100 is capable of maintaining good RF performance.

In addition, the antenna module 100 may further include a tuning switch electrically connected to the printed circuit board 20. The tuning switch is configured for adjusting connecting states of the first ground point 201a and the second ground point 201b, based on the operation states of the first feed point 202a and the second feed point 202b, so as to adjust an operation frequency band of the antenna module 100. In the present embodiment, the tuning switch may adjust the connecting states of the first ground point 201a and the second ground point 201b by switching on or switching off the second connecting piece 2011a and the fourth connecting piece 2011b.

For example, when the mobile device using the antenna module 100 is held by a user's right hand, the first feed point 202a is controlled to perform feeding operation while the second feed point 202b is controlled to be in an OFF state, in this circumstance, the antenna module 100 can operate in different frequency bands by adjusting the connecting states of the first ground point 201a and the second ground point 201b, as illustrated in the following Table 1. In Table 1, an ON state refers that the first ground point 201a or the second ground point 201b is in a short circuit or connecting state, an OFF state refers that the first ground point 201a or the second ground point 201b is in an open circuit or disconnecting state, and 3 nH refers that the first ground point 201a or the second ground point 201b is connected to a predetermined inductor with an inductance of 3 nH.

TABLE 1

| | | | Second | First | Second |
|---|---|---|---|---|---|
| First Feed | Frequency | | Feed | Ground | Ground |
| Point 202a | Band | | Point 202b | Point 201a | Point 201b |
| Low | 824-960 | MHz | OFF | ON | OFF |
| Frequency | | | | | |
| Middle | 1710-2170 | MHZ | OFF | ON | ON |
| Frequency | | | | | |
| High | 2300-2690 | MHz | OFF | 3 nH | 3 nH |
| Frequency | | | | | |

When the mobile device using the antenna module 100 is held by a user's right hand, the first feed point 202a is controlled to perform feeding operation while the second feed point 202b is controlled to stop functioning, it is calculated that the antenna module 100 can obtain an average efficiency of about 32% at the low frequency band, an average efficiency of about 49% at the middle frequency band, and an average efficiency of about 51% at the high frequency band. Compared with an operation of feeding by the second feed point 202b, antenna efficiency increments of 6%, 15% and 22% at the low frequency band, the middle frequency band and the high frequency band respectively can be obtained. In other words, the antenna efficiency of the antenna module 100 is improved.

In one embodiment, when the antenna module 100 is applied on a mobile device, the feed control switch and the tuning switch may be buttons provided at a shell of the mobile device; the feed control switch and the tuning switch may alternatively be control keys disposed on a main board of the mobile device, which can be operated by a touch panel of the mobile device. In other embodiments, the mobile device may include a sensor for detecting whether the mobile device is held by a user's right hand or left hand, and the feed control switch and the tuning switch are both disposed inside the mobile device. Based on a detected handheld state of the mobile device, the feed control switch can automatically adjust the operation states of the first feed point 202a and second feed point 202b, and the tuning switch can automatically adjust the connecting states of the first ground point 201a and second ground point 201b.

As can be seen, in the antenna module 100 as provided in the present disclosure, the first feed point 202a and the second feed point 202b are provided and can be selected to function according to a handheld state of the mobile device in which the antenna module 100 is applied, therefore, a feeding position of the antenna module 100 is adjustable to ensure a distance between the user's hand and a resonance position, and consequently, the antenna efficiency and the RF performance of the antenna module 100 are improved.

It is to be understood, however, that even though numerous characteristics and advantages of the present embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna module, comprising:
a printed circuit board;
a metal frame surrounding the printed circuit board, the metal frame comprising a metal radiating portion corresponding to the printed circuit board; and
a first feed point, a second feed point, a first ground point and a second ground point on the printed circuit board and electrically connected to the metal radiating portion;
wherein the first feed point and the second feed point are symmetrically disposed at two opposite sides of a central axis of the printed circuit board; the first ground point and the second ground point are respectively disposed corresponding to the first feed point and the second feed point.

2. The antenna module of claim 1, wherein the first ground point and the second ground point are also symmetrically disposed at two opposite sides of the central axis of the printed circuit board.

3. The antenna module of claim 2, wherein the first feed point is located between the first ground point and the central axis of the printed circuit board; the second feed point is located between the second ground point and the central axis of the printed circuit board.

4. The antenna module of claim 1, wherein the first feed point comprises a first feed piece electrically connected to the metal radiating portion, and a first connecting piece electrically connected between the first feed piece and the printed circuit board; the first ground point comprises a first ground piece attached on and electrically connected to the printed circuit board, and a second connecting piece electrically connected between the first ground piece and the metal radiating portion.

5. The antenna module of claim 4, wherein the second feed point comprises a second feed piece electrically connected to the metal radiating portion, and a third connecting piece electrically connected between the second feed piece and the printed circuit board; the second ground point comprises a second ground piece attached on and electrically connected to the printed circuit board, and a fourth connecting piece electrically connected between the second ground piece and the metal radiating portion.

6. The antenna module of claim 5, further comprising a feed control switch electrically connected to the printed circuit board, wherein the feed control switch is configured for controlling operation states of the first feed point and the second feed point.

7. The antenna module of claim 6, wherein the feed control switch controls the operation states of the first feed point and the second feed point by switching on or switching off the first connecting piece and the second connecting piece.

8. The antenna module of claim 5, further comprising a tuning switch electrically connected to the printed circuit board, wherein the tuning switch is configured for adjusting connecting states of the first ground point and the second ground point.

9. The antenna module of claim 8, the tuning switch adjusts the connecting states of the first ground point and the second ground point by switching on or switching off the second connecting piece and the fourth connecting piece.

10. The antenna module of claim 1, wherein a first break point and a second break point are formed at the metal radiating portion.

11. The antenna module of claim 10, wherein the first break point and the second break point are symmetrically disposed at two opposite sides of the central axis of the printed circuit board.

12. The antenna module of claim 10, wherein the metal radiating portion comprises a bottom plate and two arc-shaped plates, the two arc-shaped plates respectively extend from two opposite ends of the bottom plate.

13. The antenna module of claim 12, wherein the first break point and the second break are respectively formed at ends of the two arc-shaped plates.

14. The antenna module of claim 12, wherein the first break point and the second break are formed at the bottom plate of the metal radiating portion.

15. A mobile device, comprising an antenna module, wherein the antenna module comprises:
a printed circuit board;
a metal frame surrounding the printed circuit board, the metal frame comprising a metal radiating portion corresponding to the printed circuit board; and
a pair of feed points and a pair of ground points on the printed circuit board and electrically connected to the metal radiating portion;
wherein the pair of feed points are symmetrically disposed at two opposite sides of a central axis of the printed circuit board; the pair of ground points are respectively disposed corresponding to the pair of feed points.

16. The mobile device of claim 15, wherein each of the feed points comprises a feed piece electrically connected to the metal radiating portion, and a first connecting piece electrically connected between the feed piece and the printed circuit board; each of the ground points comprises a ground piece attached on and electrically connected to the printed circuit board, and a second connecting piece electrically connected between the ground piece and the metal radiating portion.

17. The mobile device of claim 16, wherein the antenna module further comprises a feed control switch electrically connected to the printed circuit board, the feed control switch is configured for controlling operation states of the feed points.

18. The mobile device of claim 17, wherein the antenna module further comprises a tuning switch electrically connected to the printed circuit board, the tuning switch is configured for adjusting connecting states of the ground points.

19. The mobile device of claim 18, wherein the feed control switch and the tuning switch controls the operation states of the feeding points and adjusts the connecting states of the ground points according to a handheld state of the mobile device.

20. The mobile device of claim 19, further comprising a sensor for detecting the handheld state of the mobile device.
